(19) United States
(12) Patent Application Publication
(10) Pub. No.: US 2006/0106857 A1
(43) Pub. Date: May 18, 2006

(54) Method and system for assured document retention

(76) Inventors: Mark D. Lillibridge, Mountain View, CA (US); Kave Eshghi, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/988,415

(22) Filed: Nov. 12, 2004

(51) Int. Cl. G06F 17/00

(52) U.S. Cl. 707/102

(57) ABSTRACT

Embodiments of the present invention relate to a system and method of providing computer archive system accountability. In accordance with some embodiments of the present invention, the system and method may comprise receiving a plurality of documents and assigning document IDs to the plurality of documents, each of the document IDs corresponding to one of the received documents. Further, embodiments of the present invention may comprise building a hash-based directed acyclic graph (HDAG) specifying the received documents and their document IDs, the HDAG having a plurality of nodes, a root node, and a root hash, wherein the root hash depends on the HDAG and is a hash of the root node. Additionally, embodiments of the present invention may comprise making the root hash available, providing proofs that the received documents and document IDs are properly incorporated into the HDAG, and providing a copy of a particular document that corresponds to a given document ID on request.

### BACKGROUND

Computer archive systems (archive systems) may be defined as computer systems that store immutable documents (also often called files). An archive system may actually comprise one or more separate computers having specialized archive software and access to a large amount of storage space (e.g., hard drives, magnetic tapes). Archive systems may be owned and/or operated by a party that provides storage space and related services to clients. During typical operation of an archive system, a client acquires a restricted account on the system to allow for storage and retrieval of electronic documents. The archive system may facilitate retrieval of such stored documents by utilizing document identification codes. For example, when presented with a document by a client, a computer archive system may produce a short and unique document identification code (document ID) that is assigned to that particular document.

After a document ID is assigned, an archive system operator or client may retrieve that document from the computer archive system at any time by requesting the relevant document ID. Whether a requested document is on disk or on tape, the archive system may locate it and retrieve a copy. However, archive systems do not always properly maintain documents and document copies. Equipment and equipment operators often fail or perform inadequately. For example, typical archive systems create potential for error by periodically copying documents to other storage media (e.g., disk, tape) from hard drive storage space to improve cost efficiency. Further, such storage media may be handled within the archive system by a robot system, which introduces more potential for error in the retrieval of thousands of storage media. While many archive systems provide reasonably safe long-term storage for client documents, situations may occur in which some documents may be lost, damaged, overwritten, and so forth. Unscrupulous individuals may attempt to compromise archive security by attempting to directly or indirectly seek the destruction or corruption of archived information. For example, under some circumstances (e.g. embezzlement), other parties may attempt to bribe the archive operator to “lose” particular documents. Accordingly, clients of archive systems may not trust their computer archive systems or their archive system operators. Clients may desire additional measures to safeguard archived information.

### BRIEF DESCRIPTION OF THE DRAWINGS

FIG. 1 is a block diagram illustrating a method of providing computer archive system accountability in accordance with embodiments of the present invention;

FIG. 2 is a block diagram that illustrates an HDAG wherein pointers hold cryptographic hashes in accordance with embodiments of the present invention;

FIG. 3 illustrates a simple linked-list HDAG data structure representing a hash list in accordance with embodiments of the present invention;

FIG. 4 illustrates an HDAG data structure including fields holding the size of the remaining list in each node in accordance with embodiments of the present invention;

FIG. 5 illustrates another HDAG data structure representing a hash list in accordance with embodiments of the present invention;

FIG. 6 illustrates an exemplary HDAG in accordance with embodiments of the present invention;

FIG. 7 illustrates an exemplary skip list in accordance with embodiments of the present invention;

FIG. 8 illustrates append-only persistent skip lists in accordance with embodiments of the present invention;

FIG. 9 illustrates an exemplary tree and its interpretation under a range of effective sizes in accordance with embodiments of the present invention;

FIG. 10 illustrates an HDAG in accordance with embodiments of the present invention;

FIG. 11 illustrates a list of lists HDAG structure in accordance with embodiments of the present invention;

FIG. 12 illustrates a binary search tree in accordance with embodiments of the present invention; and

FIG. 13 illustrates an exemplary HDAG data structure in accordance with embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. It should be noted that illustrated embodiments of the present invention throughout this text may represent a general case.

It is now recognized that it may be beneficial for computer archive systems to be accountable. An accountable computer archive system may comprise a system that enables system operators to be held accountable. Accordingly, the present disclosure describes a system and method for building and establishing archive system accountability. In other words, embodiments of the present invention provide assured document retention. Accountable archive systems may reduce the trust clients, owners, and other users need place in their archive systems, archive system providers, and archive system operators. For example, in accordance with embodiments of the present invention, if an archive system provider reneges on its contract with a client by failing to return the correct (unchanged) document corresponding to its respective document ID, then the document requestor will have irrefutable evidence of this failure.

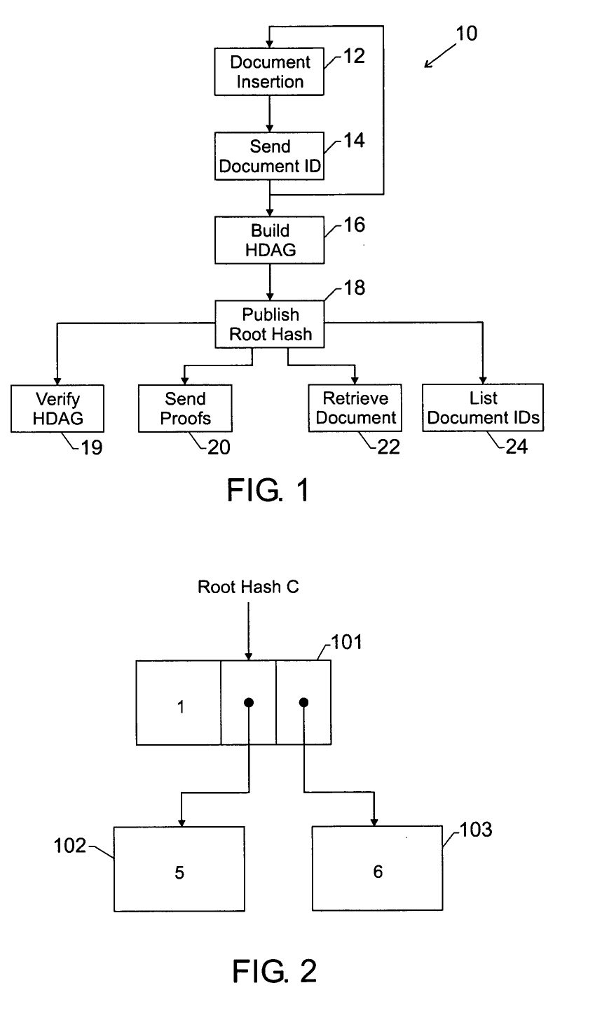

FIG. 1 is a block diagram illustrating a method of providing computer archive system accountability in accordance with embodiments of the present invention. The method is generally referred to by reference numeral 10. In some embodiments of the present invention, the blocks in the illustrated method 10 do not operate in the illustrated order. While FIG. 1 separately delineates specific method operations as individual blocks, in other embodiments, individual blocks may be split into multiple blocks. Similarly, in some embodiments, multiple blocks may be combined into a single block.

Block 12 of FIG. 1 represents insertion of a document into an archive system. The insertion represented by block 12 may comprise a plurality of operations. For example, in some embodiments of the present invention, an archive system may receive a document, assign it a document ID, and store it with other documents submitted during a designated period (e.g., all documents submitted that day). The document ID may now be used to reference the associated document. Block 14 represents sending the assigned document ID to a client or other user. In some embodiments of the present invention, the document ID is immediately sent to the client after being assigned.

Block 16 represents building an HDAG (hash-based directed acyclic graph) that unambiguously specifies each document in the archive and their associated document ID's. An HDAG may be defined as a DAG (directed acyclic graph) wherein pointers hold cryptographic hashes instead of addresses. A cryptographic hash (shortened to hash in this document) may be defined as a small number produced from arbitrarily-sized data by a mathematical procedure called a hash function (e.g., MD5, SHA-1) such that (1) any change to the input data (even one as small as flipping a single bit) with extremely high probability changes the hash and (2) given a hash, it is infeasible to find any data that maps to that hash that is not already known to map to that hash. Because it is essentially impossible to find two pieces of data that have the same hash, a hash can be used as a reference to the piece of data that produced it; such references may be called intrinsic references because they depend on the content being referred to, not where the content is located. Traditional addresses, by contrast, are called extrinsic references because they depend on where the content is located.

A DAG may be defined as a graph having directed edges and no path that returns to the same node. The node an edge emerges from is called the parent of the node that edge points to, which in turn is called the child of the original node. Each node in a DAG may either be a leaf or an internal node. An internal node has one or more child nodes whereas a leaf node has none. The children of a node, their children, and so forth are the descendents of that node and all children of the same parent node are siblings. If every child node has no more than one parent node in a DAG and every node in the DAG is reachable from a single node (called the root node), then that DAG is a tree. Contrary to physical trees, computer trees are usually depicted with their root at the top of the structure and their leaves at the bottom. HDAG's that are trees are sometimes referred to as Merkle Trees. Once the new HDAG is constructed, its root cryptographic hash (root hash) may be published, as illustrated by block 18.

FIG. 2 is a block diagram that illustrates an HDAG wherein pointers hold cryptographic hashes in accordance with embodiments of the present invention. Because HDAG's use intrinsic references instead of extrinsic references, they have special properties. In particular, any change to the contents of an HDAG with extremely high probability changes all references to it and any subpart of it whose contents have changed. This makes HDAG's very useful for committing to a set of values. For example, the following may represent an unrealistic set commitment method: To commit to a set S (e.g., a set of numbers), the committer (e.g., computer archive system) builds an HDAG whose nodes contain the elements of S. One possible such HDAG encoding {1, 5, 6} is shown in FIG. 2. The root hash C (i.e., hash of the root node) depends on the entire HDAG, thus the committer will be unable to change the set once C is published. It should be noted that C is the hash of the entire root node, including the two pointers to its children, and thus depends indirectly on its children's contents, and their children's contents, and so on.

Specifically, in accordance with embodiments of the present invention, an HDAG may be produced that incorporates information relating to received documents (e.g., the documents and their assigned ID's). In some embodiments of the present invention, the HDAG is produced at the end of a period (e.g., end of the day) to allow for inclusion of all documents submitted during the period. Once the HDAG is constructed, its root cryptographic hash (root hash) may be published, as illustrated by block 18. In some embodiments of the present invention, a computer archive system widely publishes the root cryptographic hash of an HDAG once each period. Further, in some embodiments of the present invention, the HDAG for a particular period contains a pointer to the previous period's HDAG. However, there may be exceptions to such embodiments to conserve storage space. For example, on days when no documents are inserted, that day's HDAG may simply be the same as the previous day's HDAG. In this way, archive systems in accordance with embodiments of the present invention may irrevocably commit to the accepted documents and their assigned document ID's. Clients and other users may verify that each period's HDAG is sufficiently correctly formatted and includes the information from the previous period's HDAG (block 19). It is assumed that clients and other users have access to the most recently published root hash, but not to previously published values (in a timely or cheap manner).

Block 20 represents sending each user that submitted a document during the recent period a proof that their newly inserted documents and associated document ID's are properly included in the newly published HDAG. These proofs, checked by the clients, allow the clients to be sure that their documents have actually been placed in the archive. In some embodiments of the present invention, a proof of inclusion contains the relevant HDAG nodes including all of the nodes on a path from the root node to a given node, the presence and/or contents of which are being proven. For example, in reference to FIG. 2, to prove that a particular element (e.g., five) is in the set the committer committed to, he merely need supply the contents of all of the nodes (inclusive) on the path from the root node to the node containing that element; in the case of five, this would be node 101 followed by node 102. The advantage of sending just a path to the node containing that element instead of the contents of the entire HDAG is that a path is often exponentially smaller than the entire HDAG. A skeptical observer (e.g., a client) may verify such proofs by checking that the first node hashes to the published root hash C, each succeeding node's hash is contained in the preceding node as a pointer value, and that the final node contains the element whose presence is being proved. This method of proof is quite general: the presence of an arbitrary subset of nodes in an HDAG can be proved by supplying them and all their ancestors' contents. Accordingly, using the published root hash, the client or other users may check the proof.

Block 22 represents attempting to retrieve the document having a particular document ID. For example, when the document ID is valid, the archive system may first prove to the user that the hash of the document associated with the given document ID is H under the currently committed-to HDAG. The archive system may then provide the user with a document having hash H. This must be the right document, because it is computationally infeasible for the archive to find a different document with the same hash. Alternatively, in an invalid document ID case, the archive system may provide the client with a proof (which the client then checks) that the given document ID is invalid according to the currently committed-to HDAG.

Block 24 represents listing the document IDs of all documents in the archive system. In some embodiments of the present invention, this may comprise providing the current period's entire HDAG to a user. The user may then verify that the root hash of the provided HDAG matches the current period's published root hash and that all the provided HDAG's internal hashes are internally consistent. Additionally, block 24 may represent user extraction of the document ID's from the HDAG. In one embodiment of the present invention, only the root node of the HDAG is utilized in this operation.

Several different embodiments of the present invention are presented herein. These embodiments may include systems and methods for building accountable computer archive systems that provide desirable features and that avoid potential disadvantages associated with alternative embodiments. For example, in some embodiments of the present invention, the use of short document ID's may facilitate efficient use of storage space. Another benefit, in some embodiments of the present invention, relates to the fact that no secret keys are used. This avoids unauthorized accesses, uses, and potential penalties that may result if an archive system's secret key is exposed or broken. An additional benefit may be that an archive system in accordance with embodiments of the present invention may be able to produce at any time a list of all the document ID's of the documents stored in it. Moreover, embodiments of the present invention are able to prove the correctness of this list to any party. This provides useful insurance in case a user forgets a document ID. It may also be useful to auditors who wish to ensure that users are not secretly deleting documents that they were supposed to keep in the archive forever.

One particularly significant advantage of embodiments of the present invention, as illustrated by the above two advantages, is that they can be extended to provide proofs of many kinds about an archive system's operation. This is because archive systems in accordance with the present invention may be forced to maintain a complete, permanent record of their operations that cannot be altered without detection. This opens the door to more complicated policies, for which an archive could not be held accountable using alternative archive system embodiments. Archive systems in accordance with embodiments of the present invention may also easily prove the date that a document was first inserted into the archive, which may require substantial extra overhead in alternative embodiments.

While other embodiments are presently disclosed, three specific embodiments (Embodiment A, Embodiment B, and Embodiment C) of the present invention relating to building an accountable computer archive system are presented below. Each embodiment reflects a different trade-off among the efficiencies and benefits associated with the archive operations illustrated in FIG. 1. One of these embodiments may be preferable for a particular archive system, depending on the design criteria for specific systems. Embodiment A relates to assigning document ID's in sequential order in block 12, thus allowing the use of relatively short document ID's and conserving storage space. Embodiment B relates to assigning each document's hash as its document ID in block 12, thus reducing required proofs at the expense of storage space. Embodiment C relates to assigning each document's hash combined with a round number as its document ID in block 12, thus reducing required time for invalid document ID retrieval at the expense of storage space.

In Embodiment A, block 12 may comprise assigning sequential document ID's. For example, a first inserted document may be assigned ID 1, a second (new) document may be assigned ID 2, and so forth. This procedure may allow for very short document ID's because, for example, if the archive system need hold only N documents, then only log N bits may be required per document ID. The HDAG built in block 16, in accordance with Embodiment A, may contain a list of all the hashes of the inserted documents in reverse order. That is, the first element of the list is the cryptographic hash of the most recently inserted document, the second element of the list is the cryptographic hash of the second most recently inserted document, and so on until the last element of the list, which is the cryptographic hash of the first document inserted. It should be noted that this list unambiguously specifies the set of documents in the archive and their document ID's. Further, it should be noted that a document ID may be deemed valid if and only if it is positive and less than or equal to the number of elements in the list.

The basic archive operations illustrated in FIG. 1 may require proofs of the following forms: (1) there are exactly D elements in the hash list and (2) the i^{th} element from the end of the hash list is hᵢ. The first form of proof may be used to prove that a document ID is invalid because it is greater than D and to prove that the set of valid document IDs is 1 . . . D. The second form of proof may be used to prove that document ID i is associated with the document having hash hᵢ during valid retrieval (block 22) and document insertion verification (block 20).

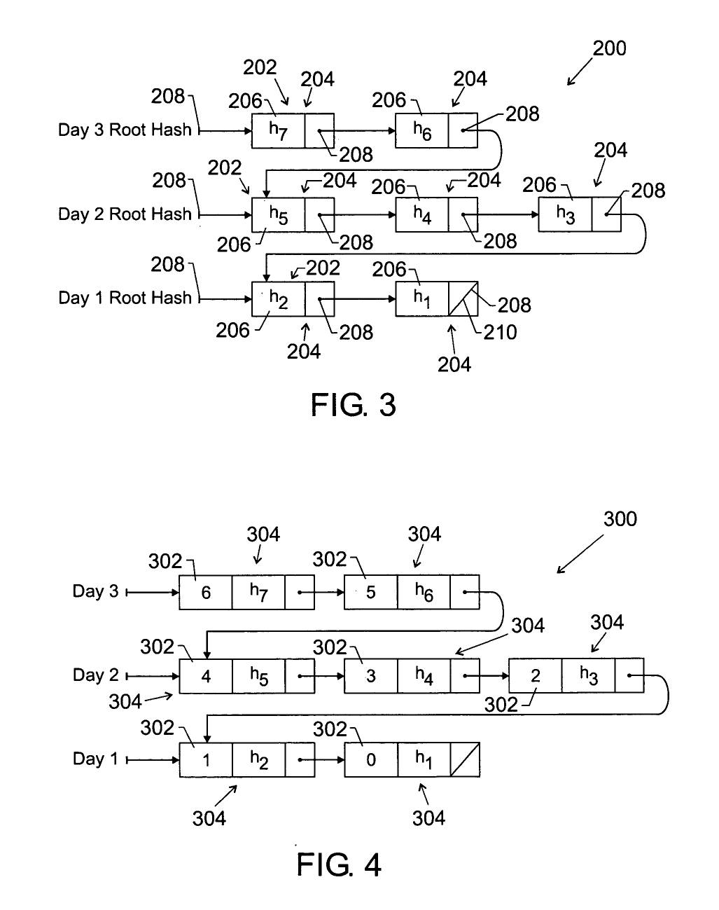

FIG. 3 illustrates a simple linked-list HDAG data structure representing a hash list in accordance with embodiments of the present invention. Specifically, FIG. 3 illustrates several instances of a data structure 200 in accordance with Embodiment A having root nodes 202 (one root node per instance), nodes 204, hash list elements 206 (e.g., h₇, h₆, h₅, h₄), and hash pointers 208. One instance is shown for each of three sequential periods (e.g., three sequential days). Note that succeeding day versions incorporate the previous versions by reference. Null hash pointers 210 are indicated in the structure 200 by a slash. In accordance with embodiments of the present invention, the null pointers 210 may be holding a special hash value null (e.g., 0) that corresponds to no known data. While this data structure 200 may be used to represent the hash list, it's efficiency is poor: with data structure 200, both required forms of proof require returning the entire HDAG, which takes O(D) space, where D is the number of documents currently in the archive system.

FIG. 4 illustrates a data structure 300 including fields 302 holding the size of the rest of the list in each node 304 in accordance with embodiments of the present invention. Specifically, data structure 300 is a data structure in accordance with Embodiment A that may be more efficient than data structure 200. By including the size of the rest of the list in each node of data structure 300, the required proofs about data structure 300 are made more efficient than those about data structure 200. In reference to data structure 300, proving that the list has D elements may only require showing the first node (O(1) space), which is labeled with the entire list's size-1. This, of course, may only work if the users can trust the size labels 302. This can be ensured by having users verify the size labels 302 of all the new nodes in each new HDAG. This need be done only once a period, for example, when the archive system publishes a new HDAG root hash (i.e., as part of block 19). For the data structure 300, this verification takes time proportional to the number of documents added to the archive during the relevant period. The labels of nodes belonging to the previous period's HDAG may be trusted because they may have been verified in earlier periods (block 19).

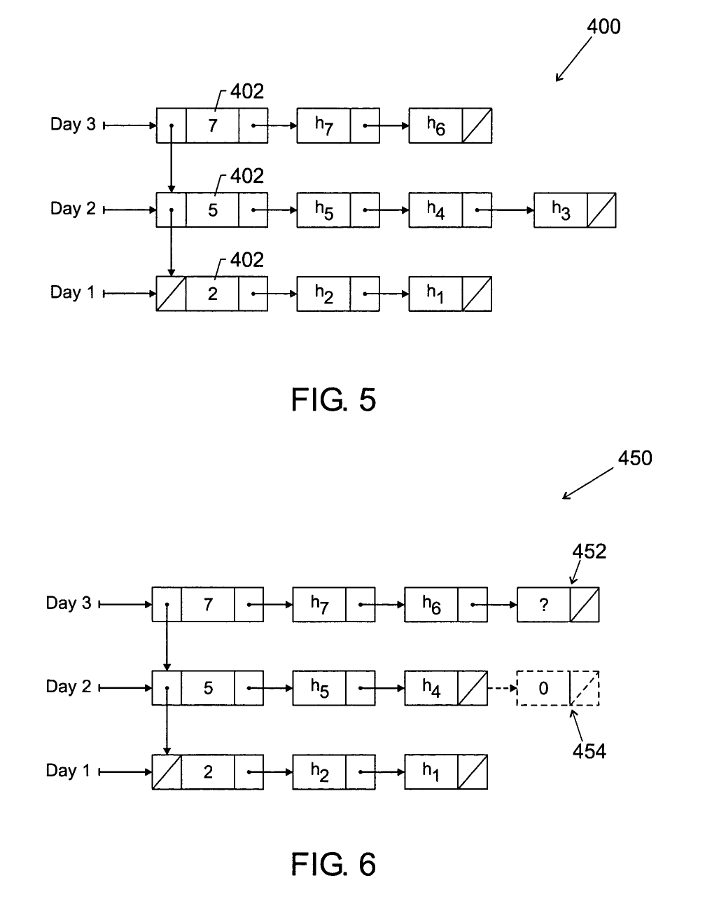

FIG. 5 illustrates another HDAG data structure 400 representing a hash list in accordance with embodiments of the present invention. Specifically, data structure 400 may be another improvement on data structures 200 and 300. In accordance with the embodiment illustrated in FIG. 5, the number of size labels 402 that must be verified per period may be reduced to 1 by making the data structure 400 a list of lists where there is one sublist per period and by only labeling the start of each sublist with size information. It should be noted that the loss of the other size information is not necessarily important because it may not be required to prove the size of the entire current list. However, verification speed may not be improved because it may be necessary to determine the new period's sublist's size in order to determine that the new list's size is correct. This may require traversing the entire new sublist.

FIG. 6 illustrates an examplary HDAG 450 in accordance with embodiments of the present invention. Specifically, HDAG 450 may illustrate that the need to compute the size of each sublist (e.g., as discussed regarding data structure 400) can be removed by defining the effective size of a sublist to be the difference between its size label and the size label of the immediately following sublist (0 if none). That is, if a sublist has more elements than its effective size, the extra elements (e.g., node 452) at the end are ignored; if the sublist has fewer elements than its effective size, operations may proceed as though it has as many 0 elements (e.g., node 454) at the end as necessary to reach its effective size. HDAG 450, under this interpretation, encodes the same underlying list of document hashes as the previous figures (i.e., FIGS. 2-5) if it is assumed that h₃ equals zero. The resulting data structure can be verified in unit time. It may only be necessary to check that the new size is greater than the previous period's size and that the pointer to the previous period's HDAG indeed points to the HDAG whose root hash was published during the previous period.

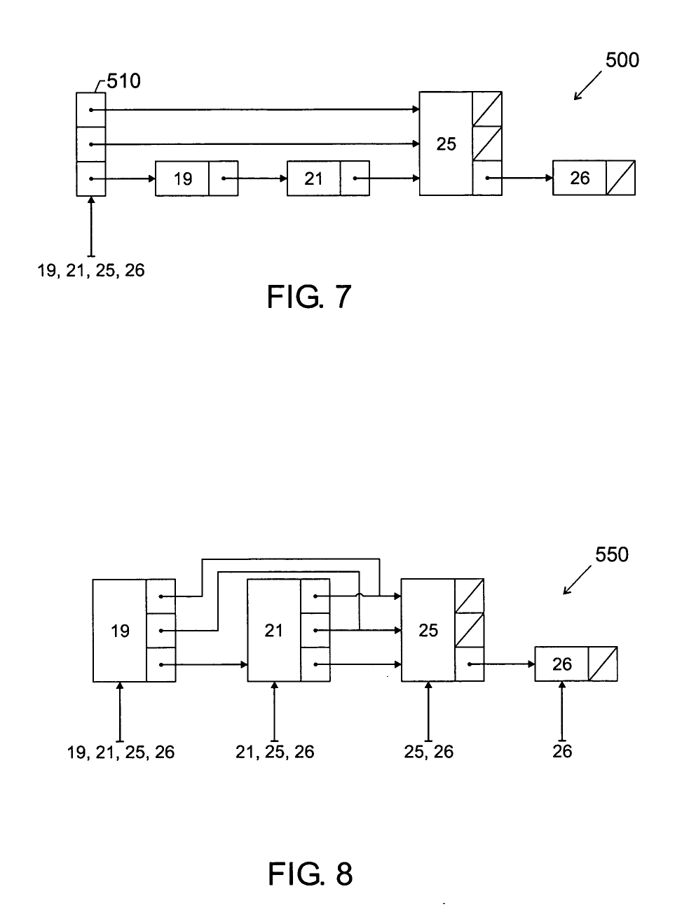

FIG. 7 illustrates an exemplary skip list 500 in accordance with embodiments of the present invention. Skip lists are defined in William Pugh, Skip Lists: a Probabilistic Alternative to Balanced Trees, Workshop on Algorithms and Data Structures (1990) at http://citeseer.ist.psu.edu/pugh90skip.html, which is incorporated herein by reference. Proving that the ith element from the end of the hash list is h may require O(D) steps (worst-case) under all of these data structures 200, 300, 400, and 450. Addressing this may require changing the archive data structure so that the backbone list (the list of sublists) can be traversed, as well as any sublist, in faster than linear time. This may be done for the backbone list by changing it from a simple linked list to an append-only persistent skip list. Skip lists can be traversed in O(log T) expected time, where T is the length of the skip list. Appending a new node to the front takes O(log T) expected space. If the number of pointers for a given node is chosen deterministically instead of probabilistically (not shown), then these times can be made deterministic.

FIG. 8 illustrates append-only persistent skip lists 550 in accordance with embodiments of the present invention. To turn a normal skip list into an append-only persistent skip list, in accordance with embodiments of the present invention, it may suffice to add the extra pointers to each node that would have been present in the list header 510 when that node was at the head of the list. An append of a single node to such a list can be verified in O(log T) expected time by the following procedure: (i) check that the new root node has at least as many pointers as the previous root node; (ii) check that newly added pointers are null; (iii) check that all old pointers have the same values as they did in the previous root node except that the bottom j pointers, j>0, point to the previous root node (j is the height/level of the previous root node).

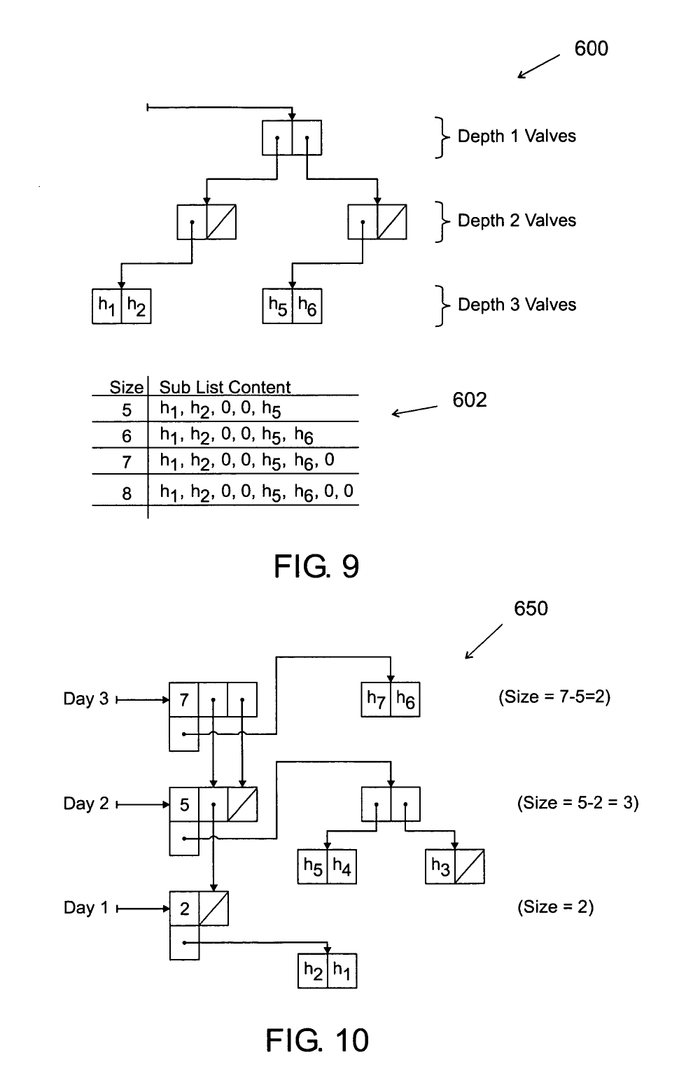

FIG. 9 illustrates an exemplary tree 600 and its interpretation 602 under a range of effective sizes in accordance with embodiments of the present invention. Improving the traversal speed for the sublists can be done by changing them from simple linked lists to complete ordered binary trees whose contents are interpreted as follows: let d be log s rounded up, where s is the sublist's effective size (note that the sublist's effective size is determined from the size labels of the backbone list); that is, 2^{d-1}<s<=2^{d}. It should be noted that there will be 2^{d} values from left to right in the tree at depth d if the tree is complete and of depth at least d. If the tree is not complete or is of insufficient depth, as many imaginary nodes containing zero data values may be inserted as necessary to make it complete and of the necessary depth. The sublist elements may then be considered to be the first s of the depth d elements. This new data structure can still be verified in unit time, but it is now possible to reach the jth element of the sublist in O(log s) time.

FIG. 10 illustrates an HDAG 650 in accordance with embodiments of the present invention. Specifically, HDAG 650 is an example of how the data of FIG. 3 may look using the data structure ideas presented in FIGS. 8 and 9. Combined, the two changes presented with regard to FIGS. 8 (using append-only persistent skip lists for the backbone list) and 9 (using trees for the sublists) allow the following exemplary operation efficiencies (variables defined below):

prove size of archive list is D: O(1)

prove that the ith element from the end is hᵢ: O(log D)

verify new root hash using yesterday's root hash: O(log T)

In turn, this means the archive's overall efficiencies using Embodiment A are:

size of document ID: log max possible D

insert a document: O(L+log D)

retrieve a document (valid ID case): O(L+log D)

retrieve a document (invalid ID case): O(1)

list the document IDs of all the documents in the archive: O(1)

verify new root hash using yesterday's root hash: O(log T)

It should be noted that L is the length of the relevant document, D is the number of documents in the archive, and T is the number of new root hashes that have been published (a.k.a., the number of days the archive has been in operation). The list-document-IDs operation is particularly fast because the ID space is continuous under this approach: in particular, 1 . . . D can be represented in O(1) space.

While Embodiment A may yield very short document IDs, it may have the drawback that valid retrieval requires a O(log D) proof; moreover, this proof may become obsolete because it is based on the latest published HDAG. This may make caching documents difficult and slow down the archive system's likely most common operation. Embodiment B addresses these potential drawbacks at the cost of using longer document IDs; in particular, it uses a document's hash as its document ID. Under this approach, proofs may not be required in the case of retrieving a valid document ID. Instead, the client or user may simply check that the returned document's hash matches the requested document ID. The HDAG may be used here primarily to let the archive reject invalid document IDs, and thus need only consist of a simple list of the document IDs issued to date. Since a document's document ID is its hash, this list can also be considered a list of the hashes of the documents inserted to date. The important proofs for this approach have the following forms: (1) hash h is not in the hash list and (2) hash h is in the hash list (this is needed for verifying insertion).

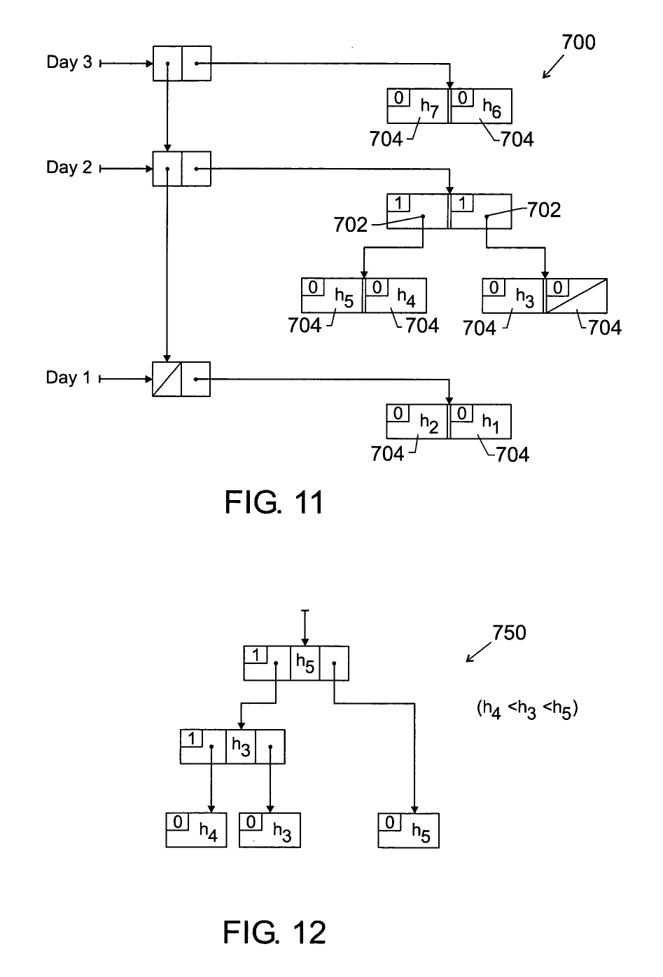

FIG. 11 illustrates a list of lists HDAG structure 700 in accordance with embodiments of the present invention. Specifically, as illustrated, in the list of lists structure 700 each sublist is an ordered binary tree. Although a simple linked list (e.g., FIG. 3) could be used in accordance with Embodiment B, that would make the hash inclusion proof (and hence document insertion) require O(D) space. In the list of lists structure 700 each sublist binary tree node has two parts, each of which is either a hash pointer 702 to another binary tree node or a data value 704; the two possibilities are distinguished by an extra bit. If the archive balances its trees, then the hash inclusion proof for hashes contained in the most recent sublist may require only O(log s) space, where s is the number of documents inserted today.

In accordance with embodiments of the present invention, an archive system may utilize various procedures to handle documents that have already been inserted. For example, when a client tries to insert a document that is already in the archive, the archive system can either add an additional copy of that document's hash to the sublist describing the current period or refer back to the copy of that document's hash that was added to the list when that document was first inserted. The archive system must refer to some copy of the document's hash in order to convince the client or other user that the document is (now) in the archive. Archive system procedures may reuse existing hash value copies in order to conserve space in case applications repeatedly insert the same documents over and over again. Doing so may require being able to produce small hash inclusion proofs for hashes contained in sublists describing earlier periods. This may be accomplished by changing the list backbone from a simple linked list to an append-only persistent skip list (as in Embodiment A; not shown); this change allows the inclusion of any hash to be proved in O(log D) steps.

FIG. 12 illustrates a binary search tree 750 in accordance with embodiments of the present invention. Specifically, binary search tree 750 is an example of how a sublist describing a subsequent period could be represented (day 2 of FIG. 11 is shown assuming h₄<h₃<h₅). It may be difficult to make the hash exclusion proof efficient in Embodiment B (the above data structures require O(D) steps) while still keeping new-root-hash verification fast. It is possible to do better at the expense of additional archive storage space by using binary search trees (e.g., binary search tree 750) instead of simple binary trees for the sublists. The data values in binary search trees are arranged in sorted order; non-leaf nodes contain a key larger than any of the data values found in that node's left subtree and smaller or equal to any of the data values found in that node's right subtree. This means that in addition to proving that a particular hash is contained in a particular search tree in O(log s) steps, a proof can be made that a particular hash is not contained in a search tree in O(log s) steps. Given the committed-to keys, there is only one possible path from the root to where a given hash can be correctly placed; showing that it is not there suffices to prove that it can't be in the tree. Using this property, hash exclusion proofs can be reduced to O(T log s′) steps where T is the number of periods the archive has been operating and s′ is the average number of documents added per period. Accordingly, an archive system's overall efficiencies using Embodiment B (reusing hash copies) are:

size of document ID: size of the used cryptographic hash (e.g., 128 bits for MD5, 160 bits for SHA-1) insert a document: O(L+log D) retrieve a document (valid ID case): O(L) retrieve a document (invalid ID case): O(T log s′) [or O(D)]list the document IDs of all the documents in the archive: O(D) verify new root hash using yesterday's root hash: O(log T)

For many applications in accordance with embodiments of the present invention, time is unimportant in the case of invalid document ID retrieval, because that case should occur only by mistake. However, this is not true for all applications. Accordingly, Embodiment C may provide much better invalid-document-ID case retrieval time at the cost of slightly longer document IDs. The document ID for a document under Embodiment C may consist of that document's hash (as in Embodiment B) combined with a round number. The round number may indicate the insertion round of which that document was part. In some embodiments of the present invention, documents may normally be inserted into the published archive in batches called rounds once a period to reduce the number of HDAG root hashes that need to be published and verified. Accordingly, round numbers may be assigned sequentially starting from one. If the archive system publishes a new HDAG root hash once a period, then the current round number is effectively just the number of periods the archive has been in operation.

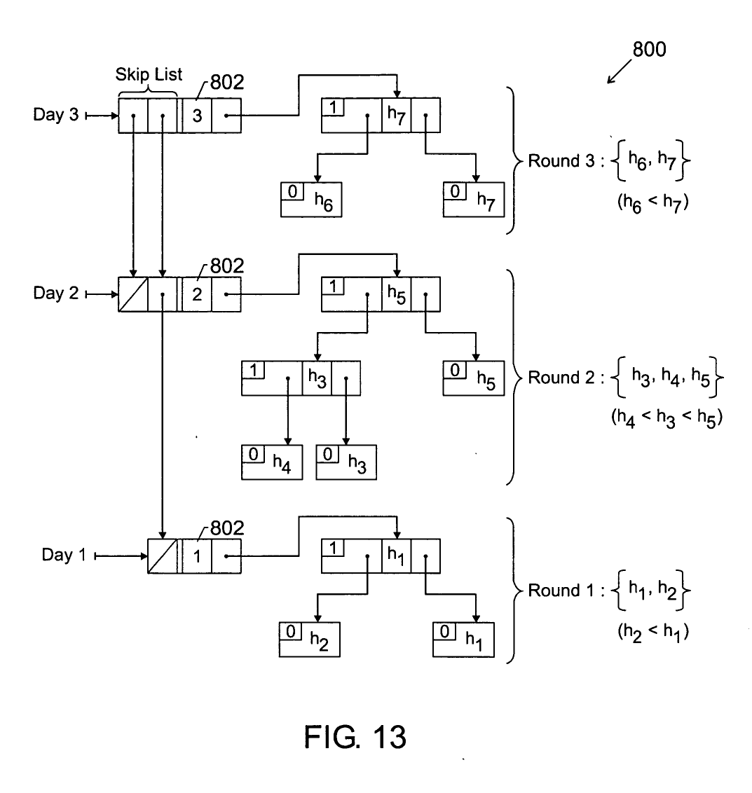

FIG. 13 illustrates an exemplary data structure 800 in accordance with embodiments of the present invention. Specifically, data structure 800 incorporates round numbers 802 representing periods in accordance with embodiments of the present invention. The incorporation of round numbers may be important in some embodiments of the present invention because it means that proving that a document ID is invalid requires proving only that its hash does not occur in that particular round. In contrast, under Embodiment B it may be necessary to prove that the document's hash did not occur in any round. By combining data structure ideas from the previous approaches, this can be done in O(log D) steps. For example, a list of lists structure may be used where there is one sublist per day; each such sublist corresponds to one round. The last sublist may contain round 1, the next-to-last sublist may contain round 2, and so on. By using binary search trees for each sublist (as in Embodiment B) it can be proven that a given round does not contain a given hash in O(log s) steps, where s is the size of that round. In order to be able to reach a given round quickly, an append-only persistent skip list with labels (as in Embodiment A) may be used for the backbone list. Instead of size labels, round number labels may be used in the backbone. The extra information provided by the size labels may not be necessary here, and would put an extra verification burden on the clients. Round number labels, by contrast, may be very easy to verify because each one is one greater than the previous one. Accordingly, a given round may be provably reached in O(log T) steps while verifying root hashes may require only O(log T) verification time (see FIG. 13). Accordingly, an archive system's overall efficiencies using Embodiment C (reusing hash copies) are:

size of document ID: size of the used cryptographic hash+log max possible T

insert a document: O(L+log D)

retrieve a document (valid id case): O(L)

retrieve a document (invalid ID case): O(log D)

list the document IDs of all the documents in the archive: O(D)

verify new root hash using yesterday's root hash: O(log T)

Embodiments of the present invention may also relate to the proof of document insertion times. Such proofs may be important to clients, other archive system users, and third-parties. For example, a client may wish to prove when a document was inserted into the archive system to either another client or to a third-party (e.g., a court during legal proceedings). Embodiments of the present invention allow this operation to be supported at minimal cost. In accordance with embodiments of the present invention, it suffices to simply timestamp, using an existing timestamp service (e.g., www.surety.com), each new period's HDAG root hash. In addition to a pointer to the previous period's HDAG, the new HDAG may include the timestamp of the prior period's HDAG. In this way, the currently committed copy of the archive will include a timestamp for each round of inserted documents. A proof of when a document was inserted into the archive then consists of a proof that that document was first inserted in a particular round combined with the timestamp for that round.

Under Embodiments A and C, to show which round resulted in the generation of a given document ID is straightforward: simply traverse the list backbone until the round with the matching round number (Embodiment C) or size labels that indicate it contains the relevant document ID (Embodiment A). This takes O(log T) steps since the backbone list is a skip list. Note that because the same document (in terms of its contents) can be assigned multiple document IDs in accordance with embodiments of the present invention, this is not a proof that the resulting timestamp corresponds to the first time the document corresponding to that document ID was inserted into the archive. Under Embodiment B, a proof of document membership in the archive (O(log D) steps) indicates a round when that document was inserted. However, that may likewise not be the only such round.

A proof that the first time a given document (in terms of its contents, not its document ID) was inserted into the archive system, it was inserted as part of round r may be more expensive. In addition to the previous proof showing the document was inserted in round r, it may be necessary to add a proof that that document was not added in rounds 1 . . . r-1. This is just a proof that the document's hash does not appear in the HDAG of period r-1, which, as discussed above, takes O(D) steps (O(T log s′) steps if binary search trees are used).

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims. For example, trees of any arity may be used instead of binary trees.

What is claimed is:

1. A method of providing computer archive system accountability, comprising:
receiving a plurality of documents;
assigning document IDs to the plurality of documents, each of the document IDs corresponding to one of the received documents;
building a hash-based directed acyclic graph (HDAG) specifying the received documents and their document IDs, the HDAG having a plurality of nodes, a root node, and a root hash, wherein the root hash depends on the HDAG and is a hash of the root node;
making the root hash available;
providing proofs that the received documents and document IDs are properly incorporated into the HDAG; and
providing a copy of a particular document that corresponds to a given document ID on request.

2. The method of claim 1, wherein the HDAG is built and its root hash published at the end of each of a plurality of time periods.

3. The method of claim 2, comprising building the HDAG to incorporate a pointer to a previous period's HDAG.

4. The method of claim 3, comprising saving storage space by using a previous period's HDAG when no documents are added in a current period.

5. The method of claim 2, comprising building the HDAG to incorporate information about when each document was received.

6. The method of claim 1, comprising providing HDAG nodes on a path from the root node of the HDAG as one of the proofs.

7. The method of claim 1, comprising assigning the document IDs to the plurality of documents from a sequence.

8. The method of claim 7, wherein the sequence is continuous.

9. The method of claim 7, wherein the sequence is not continuous.

10. The method of claim 1, comprising including a list of the received documents in the HDAG, the list comprising list nodes.

11. The method of claim 10, wherein the list of received documents is stored in a linked list.

12. The method of claim 10, comprising including a size of the rest of the list in some list nodes.

13. The method of claim 2, comprising including a list of lists of the received documents in the HDAG, the list of lists comprising a sublist for each of a plurality of time periods.

14. The method of claim 13, wherein each sublist is labeled with size information relating to the number of elements in that sublist and all following sublists.

15. The method of claim 14, wherein the number of elements a sublist is considered to have depends on the associated size labels for it and its following sublists.

16. The method of claim 13, wherein the list of lists is an append-only persistent skip list.

17. The method of claim 13, wherein some sublists are an ordered tree.

18. The method of claim 2, comprising incorporating round numbers in the HDAG, wherein the round numbers represent time periods relating to document storage times.

19. The method of claim 1, comprising including a document's hash as part of its document ID.

20. The method of claim 18, comprising including a round number associated with a particular document in that document's document ID.

21. The method of claim 18, comprising including a round number associated with a particular document in that document's document ID and including that document's hash as part of its document ID.

22. A system for providing computer archive system accountability, comprising:
a receiving module adapted to receive a plurality of documents;
an assignment module adapted to assign document IDs to the plurality of documents, each of the document IDs corresponding to one of the received documents;
a building module adapted to build a hash-based directed acyclic graph (HDAG) specifying the received documents and their document IDs, the HDAG having a plurality of nodes, a root node, and a root hash, wherein the root hash depends on the HDAG and is a hash of the root node;
an access module adapted to make the root hash available;
a proof module adapted to provide proofs that the received documents and document IDs are properly incorporated into the HDAG; and
a document module adapted to provide a copy of a particular document that corresponds to a given document ID on request.

23. The system of claim 22, wherein the building module is adapted to build the HDAG at the end of each of a plurality of time periods and the root hash module is adapted to publish a latest root hash at the end of each of the plurality of time periods.

24. The system of claim 23, wherein the building module is adapted to include a list of lists of the received documents in the HDAG, the list of lists comprising a sublist for each of a plurality of time periods.

25. The system of claim 24, wherein each sublist is labeled with size information relating to the number of elements in that sublist and all following sublists.

26. A computer program for providing computer archive system accountability, comprising:
a tangible medium;
a receiving module stored on the tangible medium, the receiving module adapted to receive a plurality of documents;
an assignment module stored on the tangible medium, the assignment module adapted to assign document IDs to the plurality of documents, each of the document IDs corresponding to one of the received documents;
a building module stored on the tangible medium, the building module adapted to build a hash-based directed acyclic graph (HDAG) specifying the received documents and their document IDs, the HDAG having a plurality of nodes, a root node, and a root hash, wherein the root hash depends on the HDAG and is a hash of the root node;
an access module stored on the tangible medium, the access module adapted to make the root hash available;
a proof module stored on the tangible medium, the proof module adapted to provide proofs that the received documents and document IDs are properly incorporated into the HDAG; and
a document module stored on the tangible medium, the document module adapted to provide a copy of a particular document that corresponds to a given document ID on request.
